(19) United States
(12) Patent Application Publication
(10) Pub. No.: US 2022/0111804 A1
(43) Pub. Date: Apr. 14, 2022

(54) SOUND PROTECTION SCREEN FOR A MOTOR VEHICLE ENGINE COMPARTMENT

(71) Applicant: TREVES PRODUCTS, SERVICES & INNOVATION, Paris (FR)

(72) Inventors: Marc Pothier, Hermonville (FR); Stéphane Ribes, Romain (FR)

(21) Appl. No.: 17/426,056

(22) PCT Filed: Feb. 10, 2020
(86) PCT No.: PCT/EP2020/053333

§ 371 Date: Jul. 27, 2021

(30) Foreign Application Priority Data
Feb. 8, 2019 (FR) 1901274
Sep. 12, 2019 (FR) 1910099

(51) Int. Cl. B60R 13/08; B32B 27/06; B32B 27/40; B32B 27/32

(52) U.S. Cl. CPC B60R 13/0838; B32B 27/065; B32B 27/40; B32B 27/32; B32B 2605/00; B32B 2307/732; B32B 2250/03; B32B 2250/04; B32B 2250/24; B60R 2013/0807

(57) ABSTRACT

The invention relates to a sound protection screen with an external shell made of a moulded thermoplastic material, an internal sub-layer based on resiliently compressible moulded polyurethane foam. The sub-layer is over-moulded with the rear side of the external shell. by over-moulding The shell is based on a sheet of thermoformed thermoplastic material and has a thickness between 0.2 and 1 mm. The shell can be a two-layered shell, with an external layer based on polyolefin. The external layer having at the side of the sub-layer, in order to allow adhesion between the shell and the sub-layer, with a rear layer based on a thermoplastic material that adheres to the foam. The shell can also be a single layer based on polyolefin, the rear side being subjected to a surface treatment that allows the adhesion to the sub-layer to be improved.

### CROSS-REFERENCE TO RELATED APPLICATIONS

This application claims the benefit of International application number PCT/EP2020/053333, filed Feb. 10, 2020; French application number 1901274, filed Feb. 8, 2019 and French application number 1910099, filed Sep. 12, 2019 the entire contents of which are incorporated herein by reference.

### TECHNICAL FIELD

The invention relates to a sound protection screen for a motor vehicle engine compartment and to a mounting of the screen.

### BACKGROUND

It is known to make a sound protection screen for a motor vehicle engine compartment, the screen comprising:
a shell based on a thermoplastic material made by injection moulding, the material being based in particular on a polyolefin to have a good resistance to fluids,
a sub-layer based on an elastically-compressible moulded polyurethane foam, the sub-layer being fastened discontinuously over the inner face of the shell, for example by snaps.

The sub-layer provides a sound protection both by absorption, due to its porous structure, and also by decoupling the shell with respect to an external support, disposed in the engine compartment, over which the screen is mounted.

As for the shell, thanks to its tightness, it allows for:
an acoustic insulation,
a protection of the underlay from the various aggressions that it might undergo: leakage of engine fluids (oil, acid battery liquid, brake fluids/washer fluid), grit impact, dusts, etc.

However, such an arrangement has several drawbacks:
high cost of the shells, in view of the amount of material involved (the shell may in particular have a thickness generally comprised between 2 and 3 mm) and at a very high cost of the injection moulding equipment,
heavy weight related to the heavy mass of a shell made by injection,
non-optimal acoustic damping of the shell because the shell is not associated with the sub-layer by continuous cohesion.

### SUMMARY OF THE INVENTION

The invention aims to overcome these drawbacks.

To this end, and according to a first aspect, the invention provides a sound protection screen 1 fora motor vehicle engine compartment, the screen comprising:
an external shell 2 based on moulded thermoplastic material,
an inner sub-layer 3 based on an elastically-compressible moulded polyurethane foam,

the screen further having the following features:
the sub-layer is associated to the rear side of the shell by over-moulding,
the shell is based on a thermoformed thermoplastic material sheet,
the shell has a thickness comprised between 0.2 and 1 mm,

the shell being selectively:
either a two-layered shell, the shell having an external layer 4 based on a polyolefin, the external layer being provided on the sub-layer side, in order to enable an adhesion between the shell and the sub-layer, with a rear layer 5 based on a thermoplastic material adhering to the foam,
or a single-layered shell, the shell being based on a polyolefin, the rear side having undergone a surface treatment allowing improving the adhesion thereof with the sub-layer.

In the case of a single-layered shell, such an improvement of the adhesion between the shell and the sub-layer is explained by an increase of the surface tension of the rear side.

Such an arrangement allows for:
a reduction in the cost of the shell, given the smaller amount of material involved in comparison with an injection moulding, and the substantially lower cost of the thermoforming moulding equipment in comparison to the injection; furthermore, the manufacturing cycle times are quite reduced in thermoforming in comparison with injection moulding,
reduced weight related to the reduced mass of a shell made by thermoforming, the shell having a very thin thickness in comparison with a shell made by injection moulding,
optimised acoustic damping of the shell as the shell is associated in a continuous cohesion with the sub-layer, due to its over-moulding by the foam sub-layer.

It should also be noted that the polyolefin used for the shell enables an easy detachment of the foam that may have leaked out at the periphery of the mould for moulding the sub-layer and spilled over onto the external face of the shell, due to the non-adhesion of a polyurethane foam on a polyolefin, which features an apolar nature.

According to another aspect, the invention provides a mounting of such a screen.

### BRIEF DESCRIPTION OF THE DRAWINGS

Additional features and advantages of the invention will appear in the following description, made with reference to the appended figures, wherein:

FIG. 1 is a schematic partial sectional view of a screen mounted on a support according to a first embodiment,

FIG. 2 is a schematic partial sectional view of a screen mounted on a support according to a second embodiment.

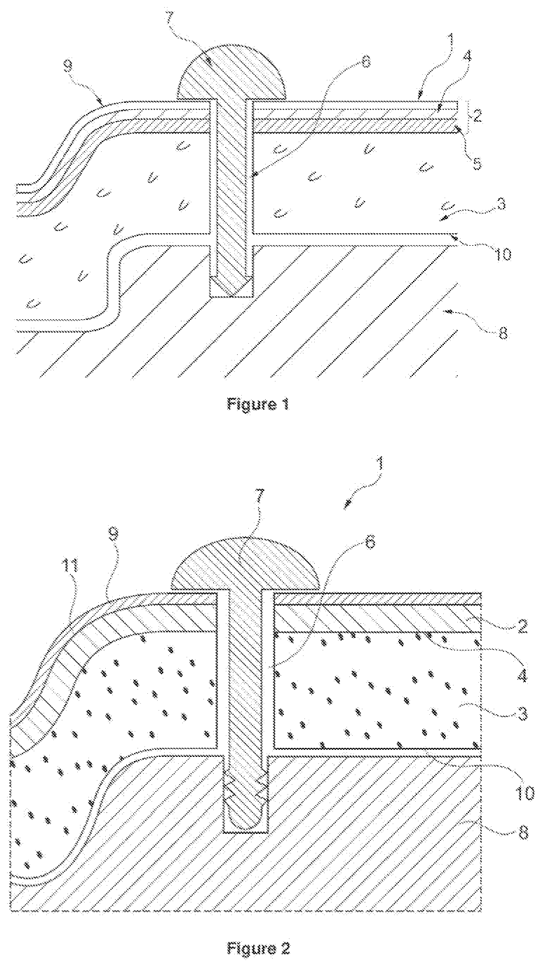

### DETAILED DESCRIPTION

A sound protection screen 1 for a motor vehicle engine compartment is now described with reference to the figures, the screen comprising:
an external shell 2 based on moulded thermoplastic material,
an inner sub-layer 3 based on elastically-compressible moulded polyurethane foam,

said screen further having the following features:
said sub-layer is associated to the rear side of said shell by over-moulding,
said shell is based on a sheet of thermoformed thermoplastic material,
said shell has a thickness comprised between 0.2 and 1 mm,

the shell being selectively:
either a two-layered shell, the shell having an external layer 4 based on a polyolefin, the external layer being provided on the sub-layer side, in order to enable an adhesion between the shell and the sub-layer, with a rear layer 5 based on a thermoplastic material adhering to the foam,
or a single-layered shell, the shell being based on a polyolefin, the rear side having undergone a surface treatment allowing its adhesion with the the sub-layer to be improved.

According to an embodiment applicable to a two-layered shell 2, the rear layer 5 is selectively based on polyethylene terephthalate (PET), polystyrene (PS), acrylonitrile butadiene styrene (ABS), polyurethane (PU), polycarbonate (PC), a mixture of polycarbonate and acrylonitrile butadiene styrene (PC-ABS), polyamide (PA), polybutylene terephthalate (PBT), polyvinyl chloride (PVC).

According to an embodiment applicable to a single-layered shell 2, the surface treatment has been carried out by flaming or by electric discharge, in particular by plasma treatment or corona treatment.

According to an embodiment applicable to all embodiments, the foam of the inner sub-layer 3 has a volumetric mass comprised between 50 g/l and 400 g/l.

According to the represented embodiments, the screen 1 comprises at least one orifice 6 crossing the shell 2 and the inner sub-layer 3, to enable the passage of a means 7 for fastening the screen to an external support 8 disposed in the engine compartment.

The presence of the shell 2 allows for an improved hold of the fastening means 7 on the screen 1, with a reduced risk of tearing thanks to the reinforcement provided by the shell.

According to one embodiment, the shell 2 is provided with a graining formed over its rear side, to enlarge the adhesion surface of the shell with the sub-layer 3.

According to the represented embodiments, the external face 11 of the shell 2 is coated with a coating material layer 9, for example a non-woven material.

A mounting of such a screen 1 on an external support 8 disposed in the engine compartment is now described, the mounting comprising the screen and the support, the face 10 of the sub-layer 3 facing towards the support having a geometry substantially complementary to that of the support to substantially match with the shape thereof, such an arrangement allowing to limit the acoustic radiation.

Finally, a first method for manufacturing such a screen 1 comprising a two-layered shell 2 is described, the method comprising the following steps:
providing a sheet of thermoplastic material having a thickness comprised between 0.2 and 1 mm, the sheet having a polyolefin-based external shell 4, the external layer being provided with a rear layer 5 based on a thermoplastic material adapted to adhere to a polyurethane foam,
making a shell 2 by thermoforming of the sheet, for example with an infrared heating and application of an underpressure in the thermoforming mould,
disposing the shell in a reaction injection mould (RIM),
injecting an elastically-compressible foam precursor mixture into the shell so that it undergoes an expansion in the moulding cavity defined by the mould and forms an sub-layer 3 over-moulding the shell,
after expansion and moulding of the foam, demoulding the obtained screen.

Finally, a second method for manufacturing such a screen 1 comprising a single-layered shell 2 is described, the method comprising the following steps:
providing a sheet of thermoplastic material having a thickness comprised between 0.2 and 1 mm, the sheet being based on a polyolefin,
carrying out a thermoforming of the sheet to obtain a shell 2, the thermoforming:
being followed by a surface treatment of the rear side of the shell,
or being preceded by a surface treatment of a face of the sheet intended to form the back face,
disposing the shell in a reaction injection mould (RIM), the rear side being directed towards the moulding cavity,
injecting an elastically-compressible foam precursor mixture over the back face so that it undergoes an expansion in the cavity and forms an sub-layer 3 over-moulding the shell,
after moulding of the foam, demoulding the obtained screen.

What is claimed is:

1. A sound protection screen for a motor vehicle engine compartment, the screen comprising:
an external shell based on a moulded thermoplastic material,
an inner sub-layer based on an elastically-compressible moulded polyurethane foam, the sound protection screen wherein:
the inner sub-layer is associated to the rear side of the external shell by over-moulding,
the external shell is based on a thermoformed thermoplastic material sheet,
the external shell has a thickness comprised between 0.2 and 1 mm, said external shell further comprising
either a two-layered shell, the two-layered shell having an external layer based on a polyolefin, the external layer being provided on the inner sub-layer side, in order to enable an adhesion between the inner shell and the sub-layer, with a rear layer based on a thermoplastic material adhering to the foam,
or a single-layered shell, the single-layered shell being based on a polyolefin, the rear side having undergone a surface treatment allowing improving the adhesion with the sub-layer.

2. The sound protection screen according to claim 1, wherein the rear layer of the two-layered shell is based on at least one of polyethylene terephthalate (PET), polystyrene (PS), acrylonitrile butadiene styrene (ABS), polyurethane (PU), polycarbonate (PC), a mixture of polycarbonate and acrylonitrile butadiene styrene (PC-ABS), polyamide (PA), polybutylene terephthalate (PBT), or polyvinyl chloride (PVC).

3. The sound protection screen according to claim 1, wherein the surface treatment of the single-layered shell has been carried out by flaming or by electric discharge.

4. The sound protection screen according to claim 1, wherein the foam of the inner sub-layer has a volumetric mass comprised between 50 g/l and 400 g/l.

5. The sound protection screen according to claim 1, wherein the sound protection screen comprises at least one orifice crossing the external shell and the inner sub-layer, to enable the passage of a fastner configured to fasten the sound protection screen to an external support disposed in the engine compartment.

6. The sound protection screen according to claim 1, wherein the external shell is provided with a graining formed over its rear side, to enlarge the adhesion surface of the external shell with the inner sub-layer.

7. The sound protection screen according to claim 1 wherein the external side of the external shell is coated with a coating material layer.

8. The mounting of a screen according to claim 1 on an external support disposed in the engine compartment, the mounting comprising the sound protection screen and the external support, the inner sub-layer having a face, the face of the inner sub-layer directed towards the external support having a geometry substantially complementary to that of the external support to substantially match with the shape of the external support.
